(19) United States
(12) Patent Application Publication
(10) Pub. No.: US 2012/0152085 A1
(43) Pub. Date: Jun. 21, 2012

(54) Heel the beat kick-peddle

(76) Inventor: Brian P. G. Gordon, SR., Buffalo, NY (US)

(21) Appl. No.: 13/134,906

(22) Filed: Jun. 21, 2011

Related U.S. Application Data
(60) Provisional application No. 61/398,392, filed on Jun. 24, 2010.

(51) Int. Cl. G10D 13/02

(52) U.S. Cl. 84/422.1

(57) ABSTRACT

In conclusion by designing and constructing a base-drum kick-pedal in this form and fashion it provides a drummer a more natural and comfortable motion to the foot, as the foot compresses the pedal to engage the mallet to strike the base drum. Because it is easier to raise and lower the heel of the foot as opposed to raising and lowering the ball of the foot. Thus making it more sensible to move the compression capability of the compression pedal that engages the mallet to strike the base-drum from the front to the rear of the base-drum kick pedal.

### CROSS REFERENCE TO REFATED APPLICATIONS

This application claims the benefit of U.S. Provisional Patent Application No. 61/398,392, which is incorporated by Brian P. G. Gordon Sr. born Apr. 1, 1965, with the last four number of social ID being (6133).

### FIELD OF THE INVENTION

The present invention relates to musical instruments. More particularly, the invention relates to the Base-Drum Kick-Peddle, which engages the mallet to strike the base-drum by the lowering of the heel rather than the lowering of the ball of the foot.

### BACKGROUND OF THE INVENTION

The invention will be describe with reference to a base-drum kick-peddle used by drummers within the music industry.

It is the desire of a drum player to be able to produce a precise and pronouncing sound on the kick-base drum, as it is vital in keeping the temple while playing the drums. What is needed is a kick-peddle that will provide a more natural means of incorporating the sound of the base when playing the drums.

Although there are other kick-peddle for base-drums in the music industry through out the world, there are no base-drum kick-peddles that provide a more natural way to engage the mallet of a kick-peddle to strike the base drum.

### SUMMERY OF THE INVENTION

The present invention provides a base-drum kick-pedal that engages the mallet to strike the face of the base drum by compressing the pedal with the lowering of the heel instead of the ball of the foot. The invention describe herein has one mallet, but other numbers of mallets may be provided. The kick-pedal is operated by chain pulley system that extends from mallet and runs underneath to the rear of the compression-pedal. This new concept will also be applied to the high-hat-cymbals and electronic musical devices and machines.

### BRIEF DESCRIPTION OF THE COPONENTS

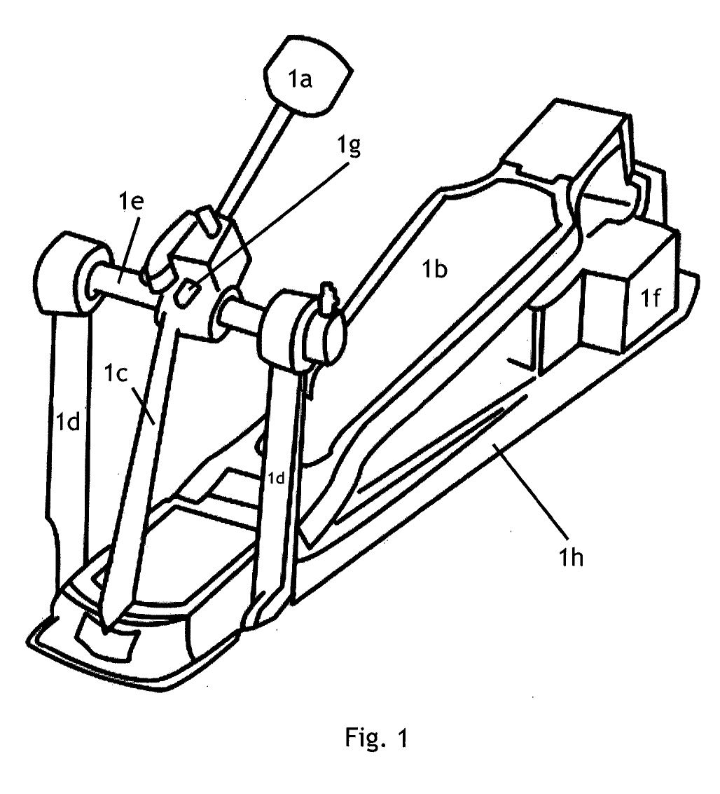

FIG. 1, a mallet connected to a metal rod 1a, a mallet holder that includes a height adjuster-nut and a chain tension screw 1g, a pull-chain 1c, a rotation-shaft 1e, the shaft-brackets 1d, the compression-pedal 1b, the adjustable compression-pedal-stop 1f, the housing-shoe 1h. FIG. 1 is an illustration that numerically labels the different components of the kick-pedal.

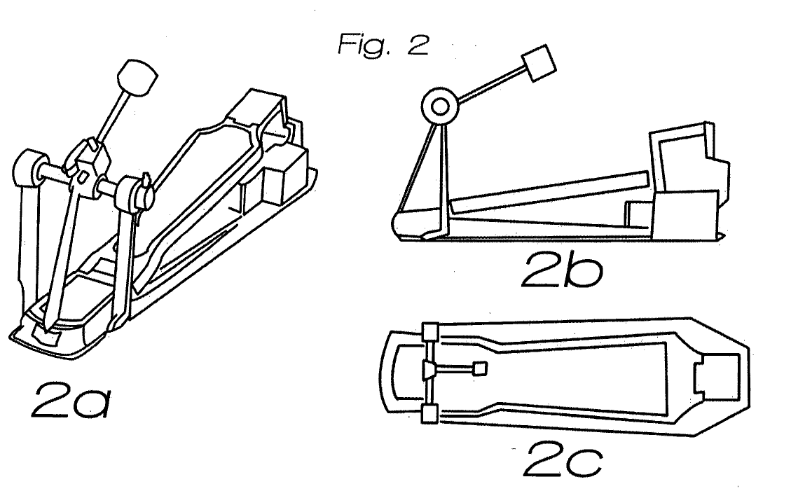

FIG. 2 is illustrations of angle views 2a, side view 2b, and top view 2c of the kick-pedal.

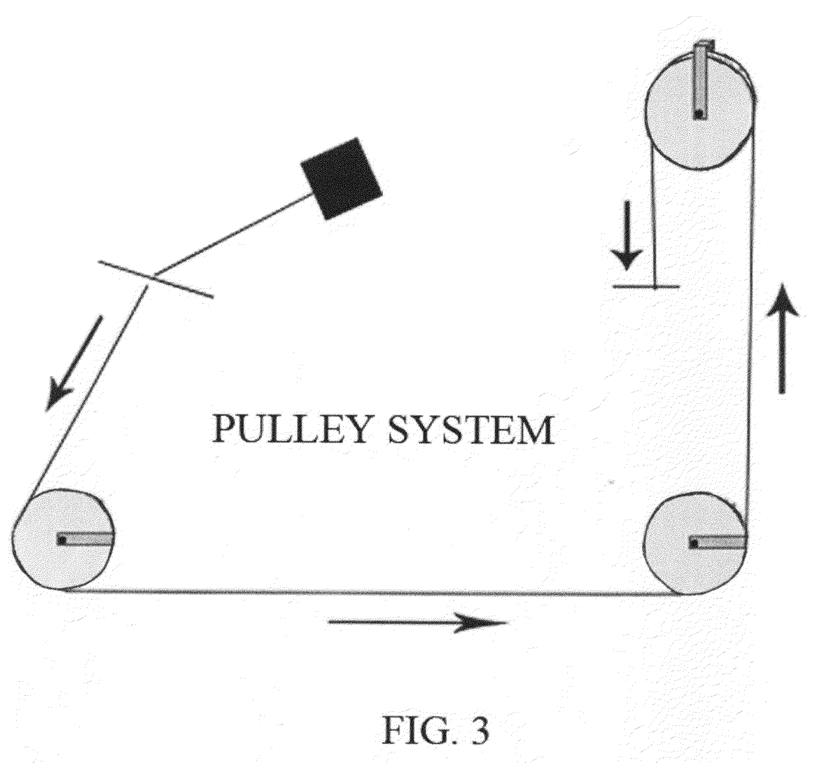

FIG. 3 is an illustration of the way the pull-chain system will be constructed.

### DETAILED DESCRIPTION

The present invention illustrated in FIG. 1 will be made of some type of light metal or metal alloy. The present invention provides a base-drum kick-pedal FIG. 1 having a mallet connected to a metal rod 1a. The mallet holder that includes a height adjuster nut and a chain tension screw a7. The rotation shaft 1e that advances the mallet a1 to strike the face of the base-drum which is set into motion by the pull-chain 1c. The shaft brackets 1d which holds the rotation shaft 1e. The compression pedal 1b that when compressed by the lowering of the heel of the foot propels the mallet 1a forward to strike the face of the base-drum. The compression-pedal-stop 1f which will prevent the kick-pedal 1b from being compressed flush to the housing-shoe of the kick-pedal. The kick-pedal stop will also be spring loaded so that the kick-pedal 1b will always return to a ready position to be compressed and thus giving the drummer added support in the rest or ready position. Then there is the housing-shoe which is the frame that holds the entire Hell The Beat Kick-Pedal components 1h.

1. This is a base-drum kick-pedal that comprises of all basic component of a common base-drum kick-pedal, a mallet connected to a metal rod 1a, a mallet holder that includes a height adjuster-nut and a chain tension screw a7, a rotation-shaft 1e, the shaft-brackets 1d, the compression-pedal 1b, the compression-pedal 1b, the housing-shoe 1h how ever what is being claimed is that: instead of the pedal 1b that propels the mallet to strike the base-drum being compressed by the ball of the foot it is compressed with the heel of the foot and is located at the rear instead of the front of the kick-pedal: Instead of the pull-chain 1c extending from the mallet-holder 1g and connects to the toe off the pedal, it extends from the mallet-holder 1g down the front and underneath to the rear of the housing-shoe 1h and connects to the heel rather than the toe of the of the compression-pedal 1b. There is also the added feature of a compression-pedal-stop that would prevent the compression-pedal from being compressed directly flush to the housing-shoe 1h of the heel the beat kick-pedal FIG. A.
